(19) United States
(12) Patent Application Publication
(10) Pub. No.: US 2024/0309853 A1
(43) Pub. Date: Sep. 19, 2024

(54) A WIND TURBINE BLADE COMPRISING A POTENTIAL CONTROL ARRANGEMENT

(71) Applicant: WICETEC OY, Helsinki (FI)

(72) Inventors: Sisu NISKANEN, Helsinki (FI); Tomas WALLENIUS, Helsinki (FI); Aki VÄNTTINEN, Helsinki (FI)

(21) Appl. No.: 18/271,570

(22) PCT Filed: Jan. 11, 2022
(86) PCT No.: PCT/FI2022/050018

§ 371 Date: Jul. 10, 2023

(30) Foreign Application Priority Data
Jan. 12, 2021 (FI) 20215025

(51) Int. Cl. F03D 80/30; F03D 1/06

(52) U.S. Cl. CPC F03D 80/301; F03D 1/0681; F05B 2230/60

(57) ABSTRACT

A wind turbine blade comprising a blade body, at least three electrically conductive elements comprising conductive material, said conductive elements optionally comprising at least one lightning conductor, at least one spar cap, and at least one heating arrangement, and a potential control arrangement, wherein the at least three conductive elements have longitudinal axes that are essentially codirectional with a longitudinal axis of the blade body. The potential control arrangement comprises a plurality of coupling devices, each of which coupling at least two of said conductive elements, each coupling device and being positioned at predetermined locations with respect to a blade axis being a longitudinal axis of the blade body.

### TECHNICAL FIELD OF THE INVENTION

The invention relates to wind turbines in general. More specifically, the invention relates to a potential control arrangement for a wind turbine blade.

### BACKGROUND OF THE INVENTION

Wind turbines typically comprise systems for protection against lightning strikes, which is often realized through provision of one or more lightning conductors along a wind turbine blade. The lightning conductors are electrically coupled to ground.

Some wind turbine blades comprise conductive material e.g. in parts of the blade body. For instance, carbon fiber reinforced plastic may be used in structural elements of the blade, such as in spar caps. The conductive material may elicit electrical discharges or arcs when lightning strikes the turbine blade, due to a potential difference between the conductive material and a lightning conductor which is being struck by lightning.

It is generally known that equipotential bonding may help to reduce the risk of arching between conductive systems at different potentials. For instance, general lightning protection standards, such as IEC 62305, guide to provide equipotential bonding at 5 m intervals along a conductive element. Wind turbine blades are also known to comprise equipotential bonding between conductive spar caps and lightning conductors. In many cases, the successful prevention of arching may be challenging, leaving the blades susceptible to damage due to such arching.

Yet, in cases where wind turbine blades comprise a plurality of different types of conductive structures or elements, the protection of the blade in case of lightning strikes is even more difficult and critical while attempting to maintain the functionality of the blade structure and the associated conductive elements. The prior art does not deal with details for proving potential control arrangements for such wind turbine blades.

### SUMMARY OF THE INVENTION

An object of the invention is to alleviate at least some of the problems in the prior art. In accordance with one aspect of the present invention, a wind turbine blade is provided, the wind turbine blade comprising a blade body, at least three electrically conductive elements comprising conductive material, said conductive elements optionally comprising at least one lightning conductor, at least one spar cap, and at least one heating arrangement, and a potential control arrangement, wherein the at least three conductive elements have longitudinal axes that are essentially codirectional with a longitudinal axis of the blade body, and
said potential control arrangement comprises a plurality of coupling devices, each of which coupling at least two of said conductive elements, each coupling device being positioned at predetermined locations with respect to a blade axis being a longitudinal axis of the blade body, wherein
at least a first portion of said predetermined locations are terminal locations based at least on locations of structural discontinuation regarding at least two of the conductive elements, the first portion comprising at least one terminal location relating to a first conductive element and at least one terminal location relating to a second conductive element, and
at least a second portion of said predetermined locations are within a selected maximum distance from a terminal location or within a selected maximum distance from an adjacent predetermined location.

A method for manufacturing a wind turbine blade is also provided in independent claim 14.

Through the invention, a wind turbine blade may be provided where potential/voltage differences between conductive elements of the wind turbine blade may be regulated, with the wind turbine blade comprising at least three conductive elements. Advantageously, the potential differences may be controlled or maintained at or under a selected level such that electric arcs between the conductive elements in the case of lightning striking the blade may be prevented or at least reduced more effectively than in the prior art and/or the amount of coupling devices may be optimized or selected to provide a potential control arrangement where the amount of coupling devices may be minimized or reduced as compared to the prior art.

It was realized by the inventors that by purposive selection of the locations for coupling devices, the potential between conductive elements could be controlled in an efficient way regarding preventing or reducing electric discharge between the conductive elements in the case of lightning strikes, yet the total amount or number of separate coupling devices could be optimized or selected so that a complexity, weight, and/or cost of the total wind turbine blade could be reduced.

If the locations for coupling devices are selected based firstly on terminal locations where structural discontinuations occur in the conductive elements (at or within a predetermined distance from such locations of structural discontinuation, the structural discontinuation preferably being an end point of the conductive element) to obtain a first portion of predetermined locations, and secondly on selecting further predetermined locations to obtain at least a second portion of predetermined locations which are within a selected maximum distance from a terminal location or an adjacent predetermined location, the voltage difference between conductive elements could be controlled more efficiently.

A terminal location may refer to a location where at least one of the conductive elements comprises a structural discontinuation (such as end point). At or near the same location, it is not necessary for more than one of the conductive elements to have a location of structural discontinuation. It may be possible, however, that e.g. two of the conductive elements (or all) have e.g. end points at or around the same location.

It was also considered by the inventors that the purposive selection of locations for coupling devices could be especially beneficial in cases where a wind turbine blade comprises at least three conductive elements (particularly where the conductive elements comprise at least three structurally differing conductive elements), of which at least two comprise one or more locations of structural discontinuation along their longitudinal axes that may be aligned along the blade axis, such that the locations of structural discontinuation of the differing elements are within a threshold distance from each other or from a predetermined location along the blade axis.

The potential control arrangement may be adapted to maintain the voltage difference between at least two coupled conductive elements so that said voltage difference is maintained below a threshold voltage value, preferably below an estimated breakdown voltage, and preferably essentially along the entire longitudinal axis of the conductive element.

At at least one of the predetermined locations or within a selected threshold distance from the at least one predetermined location, at least a first coupling device may be arranged to couple a first conductive element to a second conductive element and a second coupling device may be arranged to couple the first conductive element to a third conductive element.

By arranging a first coupling device between a first and second conductive element and a second coupling device between the first and a third conductive element such that the first and second coupling devices are placed at or near one predetermined location, direct coupling of the second conductive element to the third conductive element may not be required to attain a desired voltage difference between the second conductive element and the third conductive element. If coupling is realized e.g. only between the first conductive element and the second conductive element at a predetermined location, then at this location along the blade axis, coupling between the second conductive element and the third conductive element may be necessary to prevent arching. It was found by the inventors that by arranging the predetermined locations and coupling devices as described herein, the direct coupling of the e.g. second conductive element and the third conductive element could be avoided, reducing cost and weight of the wind turbine blade, especially in the case of the second or third conductive element being a heating element, which would need surge protection devices as coupling devices. Advantageously, along the blade axis at locations where the conductive elements each span the blade axis, coupling devices may couple each of the remaining conductive elements to a selected first conductive element, e.g. lightning conductor, at or near (within a selected threshold distance) from a predetermined location.

The selected threshold distance may e.g. be 10 m or 5 m. The selected threshold distance may be based at least on a distance between the first conductive element and the second conductive element at the considered predetermined location.

The terminal locations may be based on end points of the considered conductive elements and at least one second portion of predetermined locations may be at predetermined intervals along the blade axis, adjacent predetermined locations being within the selected maximum distance from each other. The predetermined intervals may be essentially even intervals, or the intervals may differ from each other by under a selected threshold interval, such as under 15 m, preferably under 10 m, most preferably under 5 m. A maximum value for any interval may be determined through the selected maximum distance, while at least a portion of the intervals may be shorter than the selected maximum distance.

It was discovered by the inventors that the voltage difference between two conductive elements may be maintained below a threshold value effectively (preferably along an entire longitudinal axis of one of the conductive elements) by placing coupling devices (equipotential bonding devices) in the predetermined locations such that the predetermined locations are provided within a selected distance from an adjacent predetermined location.

The selected maximum distance may be under 50 m, preferably under 45 m, and most preferably under 40 m. Adjacent predetermined locations may be separated by a distance of 10-50 m, preferably 15-40 m, most preferably 20-35 m, such as about 30 m. The found values for selected maximum distance were found to be suitable maximum distance intervals for coupling devices such that the voltage difference between conductive elements could be controlled to a desired level (e.g. under a threshold value) while minimizing the amount of coupling devices that are required. By utilizing the selected maximum distance, coupling devices do not have to be placed at any more locations to achieve the desired controlling of potential.

The conductive elements may comprise at least one lightning conductor that may be electrically connected to a ground potential. The lightning or down conductor may reach from the tip of the blade to the root of the blade and be connected through the tower of the wind turbine to the ground.

The plurality of coupling devices may comprise at least one coupling device coupling the lightning conductor to a second conductive element and at least one coupling device connecting the lightning conductor to a third conductive element. At least a portion of the other conductive elements comprised in the wind turbine blade (i.e. at least the second and third conductive element) may thus be coupled, via the coupling devices, to the lightning conductor. The potential control arrangement may therefore control at least a first potential difference between the lightning conductor and the second conductive element and a second potential difference between the third conductive element and the lightning conductor or a voltage difference between all conductive elements may be controlled. Preferably, all of the considered conductive elements are coupled at least to the lightning conductor.

With the potential control arrangement, the current flowing through a lightning conductor as lightning strikes the conductor at the tip of the blade may be safely conducted to the root of the blade by preventing or reducing arcs between the conductor and the other conductive elements of the blade.

The conductive elements may comprise at least one electrically non-functional element. A coupling device coupling the electrically non-functional element to one other conductive element is advantageously a connector. An electrically non-functional element may refer herein to a conductive element that does not utilize electricity to operate. A connector may be a connector that directly electrically couples the conductive elements, and may e.g. be a wire or joint or a piece of electrically conductive material.

The conductive elements may comprise at least one structural support element, optionally a spar cap. Preferably, the conductive elements comprise at least two spar caps, wherein said spar caps may comprise carbon fiber.

The conductive elements may comprise at least one electrical device, further wherein a coupling device coupling the electrical device to at least one other conductive element is a surge protection device. The voltage difference between the electrical device and the one other conductive element may be controlled such that the elements are electrically directly coupled only if the voltage difference between them exceeds a maximum voltage value. This may ensure that electric current (and supply voltage) may be delivered to the electrical device in a normal situation, ensuring the operation of the electrical device, while in the case of a lightning strike, the voltage between e.g. the electrical device and a lightning conductor may be equalized or maintained below a threshold value.

The electrical device may in one embodiment comprise at least one heating element, optionally at least one heating mat.

The electrical device may comprise at least one electrically powered device, optionally a heating mat, and at least one power cable for feeding electrical power to said electrically powered device. The coupling devices may couple each of the at least one electrically powered device and the at least one power cable to at least one other conductive element. In the case of a conductive element that is an electrically powered device, the electrical device may often comprise at least one power cable that is also aligned along the longitudinal axis of the electrical device and therefore also along the blade axis. It may then be advantageous to place coupling devices also at predetermined location with respect to the longitudinal axis of the power cable, e.g. at least at one terminal location or end point of the power cable and at predetermined locations along the power cable which are separated by under the selected maximum distance.

Electrical device or electrically powered device may refer to a device or component that may be fed electrical power and the device uses the electrical power for operation, such as converts said electrical power to heat. The electrically powered device may additionally or alternatively e.g. be an optically active device such as lighting device or the electrically powered device may be a more complex device.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates schematically at least portions of a wind turbine blade that may be provided according to one exemplary embodiment of the invention,

FIG. 2 schematically shows at least a portion of a cross-sectional view of a wind turbine blade according to one exemplary embodiment of the invention,

FIG. 3 exhibits one exemplary structure for a spar cap,

FIG. 4 shows one exemplary structure for a heating arrangement, and

FIG. 5 illustrates schematically a wind turbine blade with conductive elements and potential control arrangement according to one exemplary embodiment of the invention.

### DETAILED DESCRIPTION

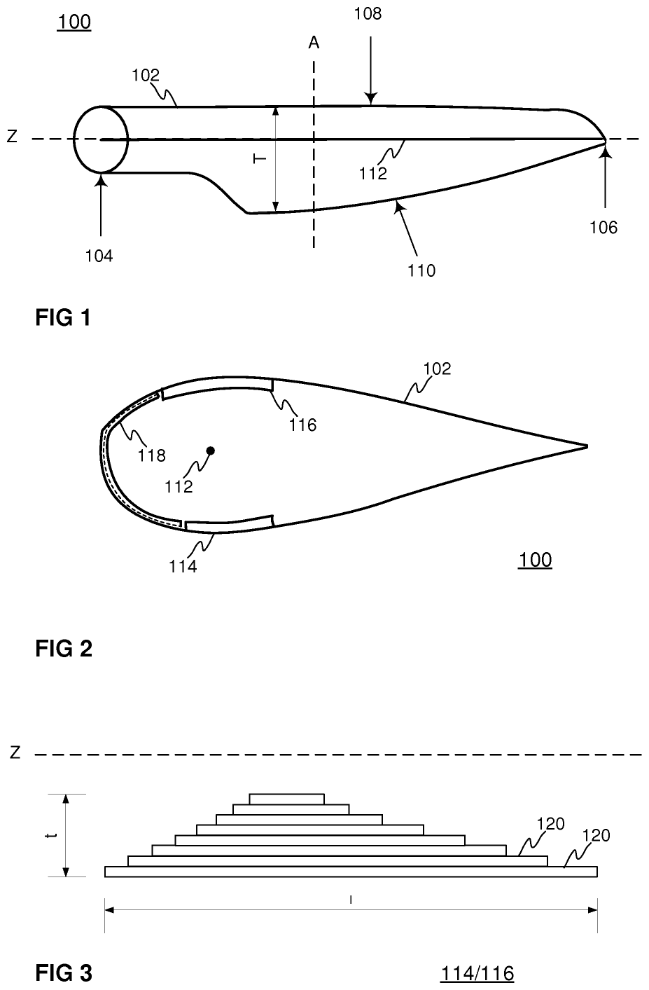

FIG. 1 shows a wind turbine blade 100 with a blade body 102. The blade body may be a composite body formed from a plurality of elements, including e.g. shells preferably comprising or being attached to reinforcements which may comprise materials such as glass and/or carbon fiber reinforced materials, for instance plastics. The blade body 102 may have a total length of e.g. 50-200 m or 80-150 m, such as for instance about 100 m along a blade axis Z.

The blade 100 comprises a root end 104 (connectable to a rotor hub and nacelle), a tip end 106, a leading edge 108, and a trailing edge 110. A thickness T of the wind turbine blade 100 may vary along the length of the blade axis Z, with T being smaller near the tip end 106 than at other parts of the blade. A thickest part (largest T) may be situated at or near the root end 104.

The blade 100 may also comprise a lightning conductor 112 that may extend from the tip 106 of the blade to the root 104. The lightning conductor 104 may be a down conductor and generally follow the blade axis Z or be essentially codirectional with said axis Z.

Alternatively, the lightning conductor 112 may comprise e.g. a plurality of preferably interconnected elements that extend from the tip 106 of the blade to the root 104 and at least partly extend along an outer surface of the blade body 102, e.g. through the elements being connected with a down conductor.

The lightning conductor 112 is preferably electrically connected to a ground potential, through the nacelle and wind turbine tower. As lightning strikes the blade and the lightning conductor 112 at the tip 106 of the blade, the induced electric current may be directed through the lightning conductor 112 to ground.

FIG. 2 shows, schematically, a cross-sectional view of the wind turbine blade 100 of FIG. 1 along line A. The down conductor 112 is depicted, while spar caps 114, 116 are provided as part of the blade body 102 or attached to the blade body 102. A suction side spar cap 114 and/or a pressure side spar cap 116 may be provided as a reinforcing structure for the blade body 102.

The spar caps 114, 116 are preferably elongated elements having longitudinal axes that are essentially codirectional with the blade axis Z. The spar caps may have a shape that is thickens at a middle portion, at least along its longitudinal axis, as will be demonstrated further below. The spar caps may be formed as monolithic bodies but in many cases are preferably comprised of layers of material.

The spar caps 114, 116 may comprise conductive material, such as carbon fibers, and may be formed from carbon fiber-reinforced materials, such as carbon fiber-reinforced plastic.

The wind turbine blade may additionally comprise an electrical device in the form of a heating arrangement comprising a heating element 118, shown in FIG. 2 as a heating mat that may be provided along the leading edge 108. The heating element 118 may be provided to span a majority of the leading edge 108 as in FIG. 2 or the heating element 118 could be shorter in width and e.g. span only an upper portion of the leading edge 108.

In the example of FIG. 2, the heating element 118 does not overlap with the spar caps 114, 116. In other embodiments, the heating element 118 could, span at least partially over one or both spar caps 114, 116.

The heating element 118 may comprise conductive material and may be configured to produce heat through resistive properties of the conductive material when an electric current is provided to the heating element 118.

The heating element 118 may be an elongated element having a longitudinal axis that is essentially codirectional with the blade axis Z.

The heating element 118 may be considered as an electrically operating device and may comprise or may be coupled to one or more conductors/power cables and a power panel, which together may be considered to form a heating arrangement (or electrical device).

The heating element 118 may be integral with the blade body 102 or it may be provided as a separate element that is coupled to the blade body 102 e.g. to a shell.

The heating element 118 may be provided as a continuous element or it may comprise a plurality of elements. The heating element may e.g. comprise a root element and tip element, as will be demonstrated below.

A lightning conductor 112, spar cap(s) 114, 116, and a heating element 118 may be conducting elements comprised in a wind turbine blade 100, between which an electric potential may be beneficial to control to prevent damage in the wind turbine blade 100 in the occurrence of lightning striking the blade 100.

It may be advantageous to control/maintain a potential difference between two of the conductive elements or between a plurality of pairs of conductive elements, such as between a first and second conductive element, between a first and third conductive element, and/or between a second and third conductive element.

FIG. 3. shows an exemplary structure for a spar cap 114, 116 that may be utilized in a wind turbine blade 100. The spar cap may comprise pultruded layers 120 comprising carbon fibers. The layers 120 may be arranged one on top of the other, while a bottom layer has largest length along the blade axis Z and subsequent layers being shorter, preferably with the topmost layer having shortest length.

The layers 120 may be arranged such that the thickness of the spar cap is tapered towards one or both ends of the spar cap 114, 116. Both ends of the spar cap may be tapered, with the tapering being steeper at one end of the spar cap. The spar cap 114, 116 usually may have a tapered end towards the tip 106 of the blade body 102 with a convergence angle that is smaller than that at the root side. The different layers 120 may be essentially equally thick.

The length l of the spar cap (defined here by the length of the longest and lowest layer 120) may be selected in relation to the length of the blade body 102 in the blade axis direction Z. The length l of the spar cap 114, 116 may be essentially equivalent to a length of the blade body 102 or the spar cap may be shorter than the length of the blade body 102, while preferably spanning a length over 50% of the blade. In one embodiment, the spar cap length may have length of e.g. 60%-90% of the blade body length, preferably 75-90% of the blade body length. Considering a blade body length of about 100 m, a spar cap may have a length l of 80-90 m, such as 86 m. In one example, a blade may have a total length of about 100 m and a suction side spar cap 114 and/or a pressure side spar cap 116 are arranged to extend from Z6.0 to Z92.0 (i.e. starting at a position of 6 m from the blade root along the blade axis and extending to 92 m).

A thickness t of the spar cap 114, 116 may at each point along the blade axis Z be defined by the thickness of the layers 120 and the number of layers at the specific point. The thickness of the layers (each layer preferably having same or similar thickness but they could also vary) may be e.g. 1-10 mm, e.g. in one embodiment the thickness of each layer 120 may be about 5 mm.

The number of totally layers 120 utilized may depend on the embodiment and could be e.g. 5-10 layer 120. In one embodiment 8 layer 120 may be applied.

A width of a spar cap 114, 116 may be for instance 200-800 mm, such as about 400 mm, wherein each layer 120 comprises two 200 mm wide pultrusions placed side-by-side chordwise on top of the blade shell.

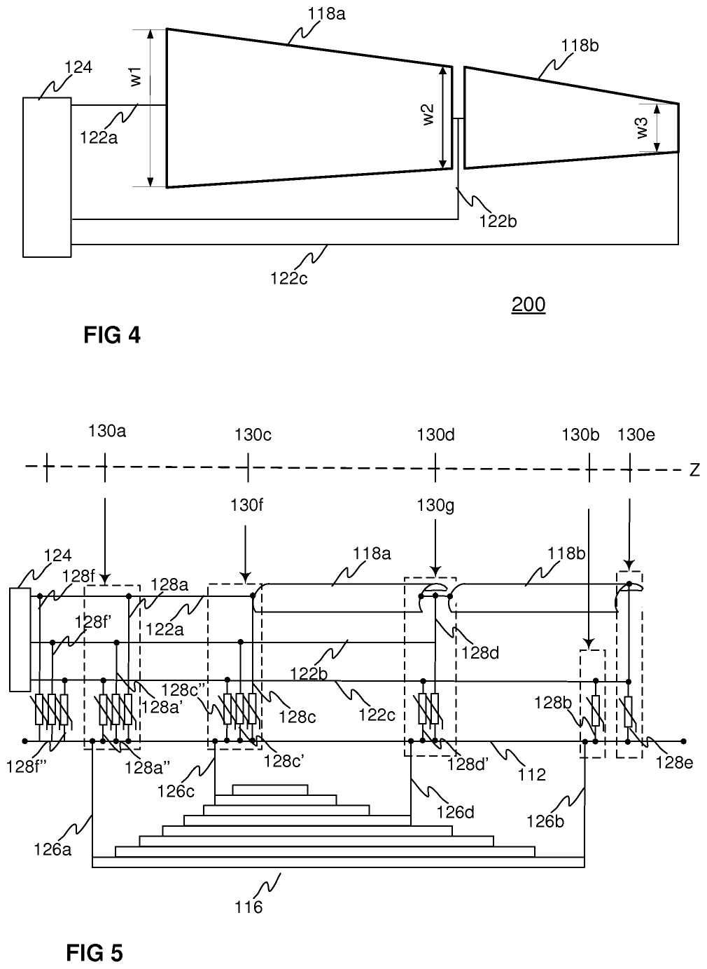

FIG. 4 shows one exemplary structure for a heating arrangement 200. The heating arrangement 200 of FIG. 4 comprises two heating mats 118. A heating arrangement could comprise only one heating mat 118 or any other number of heating mats 118. A root heating mat 118a may be configured to be arranged closer to a blade root 104 than a tip heating mat 118b, being arranged nearer to the blade tip 106.

In one exemplary embodiment, a blade length may be 100 m and a root heating mat 118a may extend from Z32.0 to Z62.0 while a tip heating mat 118b may extend from Z62.1 to Z97. A heating mat 118 could then essentially be considered to be about 65 m in length in total.

A heating element or heating mat 118 could comprise of any number of elements and could be arranged to extend at differing locations along a blade body 102. A heating element could e.g. span a length of 30-90%, 40-80%, or 50-70% of the blade body 102 along the blade axis Z.

The heating arrangement 200 of FIG. 4 comprises a root power cable 122a, a middle power cable 122b, and a tip power cable 122c. The root power cable 122a may connect a power supply 124 (comprised e.g. in the hub) with a root of the root heating mat 118a. The middle power cable 122b may connect the power panel to a tip of the root heating mat 118a and to a root of the tip heating mat 118b. The tip power cable 122c may connect the power supply 124 with the tip of the heating mat.

In embodiments with different number of e.g. heating elements, differing numbers of power cables may be utilized. For example, a power cable could be arranged to be coupled with each root and tip side end of a heating element.

In differing embodiments of the invention, a conductive element may be some other electrical device and may comprise at least one electrically powered device which could for example be powered using only one power cable (or a plurality of power cables).

In one example, chordwise widths of heating mats could be e.g. about 1.75 m for a first width w1 at the root of the root heating mat 118a, about 1.3 m for a second width w2 at the tip of the root heating mat 118a and the root of the tip heating mat 118b, and about 0.8 m for a third width w3 at the tip of the tip heating mat 118b. Of course, also differing geometries of heating mats or elements could be utilized.

In one exemplary embodiment, the tip heating mat 118b may be positioned on the leading edge of the blade, between about Z62.1 and Z97.0. The tip heating mat 118b may be coupled to the tip power cable 122c around Z97.0 and to the middle power cable 122b at about Z62.1.

In one exemplary embodiment, the root heating mat 118a may be positioned on the leading edge of the blade, between about Z32.0 and Z62.0. The root heating mat 118a may be coupled to the middle power cable 122b around Z62.0 and to the root power cable 122a at about Z32.0.

Power cables utilized with the heating mats of the example of FIG. 4 may be selected according to the electrical requirements of the arrangement, yet taking into account that the power cables could be subjected to a portion of the electric current arising in the case of lightning strikes. The tip power cable 122c could extend between about Z0 and Z97, the middle power cable 122b could extend between about Z0 and Z62, and the root power cable could extend between about Z0 and Z32. Power cables may advantageously be traced along one shear web on a side of the blade body, if a lightning conductor is traced on the other shear web.

FIG. 5 schematically illustrates a wind turbine blade 100 with conductive elements 112, 116, 118 and potential control arrangement according to one exemplary embodiment of the invention. The components of FIG. 5 are not to scale and the arrangement of the components with respect to the each other may differ from that shown, as the figure is provided for illustrative purposes. The potential control arrangement comprises a plurality of coupling devices 126, 128 that couple at least two of the conductive elements 112, 114, 116, 118. Here, the coupling devices 126, 128 couple at least one of the spar caps 114, 116 with the lightning conductor 112 and/or at least one of the heating mats 118 with the lightning conductor 112. Preferably, all of the other conductive elements 114, 116, 118 are coupled with the lightning conductor 112.

In embodiments where one of the conductive elements comprises an electrical device, said electrical device itself may form one conductive element that is to be coupled to e.g. a lightning conductor 112. Yet, if the electrical device comprises an electrically powered device and one or more power cables 122, then the electrical device and the power cable may be coupled to a lightning conductor 112. The electrically powered device may be considered as a conductive element and in some embodiments, power cables 122 may additionally be considered as conductive elements.

Coupling devices that couple electrically non-functional elements, such as the spar caps 114, 116 to e.g. the lightning conductor 112 may be connectors 126. Any type of connector/equipotential bonding element actualizing a direct electrical connection may be utilized, such as wire or cable. Advantageously, the connectors 126 are selected to withstand the current that is induced through the connector 126 in the case of a lightning strike.

Coupling devices that couple an electrical device, electrically powered device and/or power cable to e.g. lightning conductor 112 may preferably be a surge protection device 128.

The coupling devices 126, 128 are positioned at predetermined locations 130 with respect to the blade axis Z. A first portion of the predetermined locations may be terminal locations which are based at least on locations of structural discontinuation regarding at least two of the conductive elements, the first portion comprising at least one terminal location relating to a first conductive element and at least one terminal location relating to a second conductive element.

Preferably, the first portion of predetermined locations are terminal locations based on one or more locations of structural discontinuation regarding at least any electrically non-functional conductive elements comprised in the wind turbine blade and any electrically electrical devices comprised in the wind turbine blade which are to be coupled with a lightning conductor 112.

The locations of structural discontinuation may comprise at least locations of end points of the respective conductive element. The locations of structural discontinuation may also comprise some other location along a longitudinal axis of the conductive element where some aspect of the element changes considerably or to some extent, e.g. where the form, material, or shape of the conductive element exhibits a change, for example to an extent that the electrical properties of the element change over a threshold value at said location.

The first portion of predetermined locations may comprise at least locations of end points of the spar cap 116, which may be illustrated as locations 130a and 130b along the blade axis Z, with 130a corresponding to a root end point of the spar cap 116 and 130b corresponding to a tip end point of the spar cap 116. At these locations, the spar cap 116 is coupled to the lightning conductor 112 with connectors 126a, 126b. FIG. 5 only shows the pressure side spar cap 116, but preferably also a suction side spar cap 114 is provided as a conductive element. The suction side spar cap 114 may be identical in structure with the pressure side spar cap 116 and may be coupled to the lightning conductor at essentially corresponding locations as the pressure side spar cap 116.

Preferably, at or within a threshold distance from the predetermined locations 130, at least a portion or all of the remaining conductive elements are coupled to the lightning conductor 112. In the example of FIG. 5, the heating elements 118a, 118b and power cables 122a, 122b, 122c are also coupled to the lightning conductor 112 at or within a threshold distance from terminal locations 130a and 130b determined regarding the spar cap 116, where these elements extend the blade axis Z at these locations. At or within a selected threshold distance from the predetermined locations may refer to essentially at the locations or e.g. within 10 m or within 5 m from the predetermined locations.

A selected threshold distance may be based on a distance between one conductive element and a second conductive element at the considered predetermined location (such as the distance between at least one of the spar caps and the heating element or a distance between the heating element and lightning conductor, for instance), which may e.g. depend on the position of the considered predetermined location with respect to the blade axis Z or on a thickness T of the wind turbine blade at the considered predetermined location.

Near the tip end 106, such as at about Z97, the thickness T may be smaller than at other parts of the blade residing closet to the blade root. The mutual distances between conductive elements may depend on the thickness of the blade, such that as the thickness of the blade is increased, so is the distance between the conductive elements.

For instance, at about Z97, to prevent arching a selected threshold distance within which e.g. a first predetermined location and second predetermined location should be provided, where at the first predetermined location the spar cap is coupled to the lightning conductor and at the second predetermined location the heating element is coupled to the lightning conductor, may be a smaller selected threshold distance than at a position along the blade where the thickness T is larger. For example, at Z97 the selected threshold distance may be 5 m or 2 m. Here the distance (along line A, i.e. in a thickness direction of the blade) e.g. between a spar cap and a lightning conductor may be about under 50 cm or even under 25 cm, while the distance between for instance the lightning conductor and heating element may also be in a similar range.

A thickest part of the blade may be situated at or near the root end 104. Here, or e.g. at or around Z6 the selected threshold distance may be 10 m, while a distance between conductive elements that are to be coupled may be about 1-2 m. The selected threshold distance may be based on the distance between the conductive elements or the position of the considered predetermined location with respect to the blade axis Z (or blade thickness) such that the selected threshold distance is a linear function of the distance between conductive elements or the blade axis Z or thickness, and may e.g. decrease linearly or incrementally from about 10 m to about 5 m.

Thus, surge protection devices 128a, 128a′, and 128a″ may be provided to couple the root power cable 122a to the lightning conductor 112, the middle power cable 122b to the lightning conductor 112, and the tip power cable 122c to the lightning conductor 112, respectively essentially at the terminal location 130a. surge protection device 128b may be provided to couple the root power cable 122a to the lightning conductor 112 essentially at the terminal location 130b.

The first portion of predetermined locations may also comprise at least locations of end points of the root heating mat 118a and the tip heating mat 118b. The end point of the root heating mat 118a and the starting point of the tip heating mat 118b are configured near each other (near in this case meaning e.g. within 1 m or within 0.5 from each other, with the distance between these being 0.1 m in this particular example), in which case it may be sufficient to provide only one surge protection device at one location between these points. Thus, the first end portions may comprise predetermined locations 130c corresponding to the root end point of the root heating mat 118a, location 130d corresponding collectively to the tip end point of the root heating mat 118a and the root end point of the tip heating mat 118b, and location 130e corresponding to the tip end point of the tip heating mat 118b. Corresponding to locations 130c, 130d, and 130e, surge protection devices 128c, 128d, and 128e may be provided, respectively, to couple the lightning conductor 112 and the heating mats 118.

At (or within a threshold distance from) location 130c, the spar cap 116 is preferably coupled to the lighting conductor 112 via connector 126c, while the middle power cable 122 b is coupled to the lighting conductor 112 via surge protection device 128c′, and the tip power cable is coupled to the lighting conductor 112 via surge protection device 128c″.

At (or within a threshold distance from) location 130d, the spar cap 116 is preferably coupled to the lighting conductor 112 via connector 126d and the tip power cable 122c is coupled to the lighting conductor 112 via surge protection device 128d′.

At least a second portion of the predetermined locations comprise at least locations which are within a selected maximum distance from a terminal location or within a selected maximum distance from an adjacent predetermined location. The selected maximum distance may be under 50 m, preferably under 45 m, most preferably under 40 m. Adjacent predetermined locations may be separated by a distance of 10-50 m, preferably 15-40 m, most preferably 20-35 m. In the example of FIG. 5, adjacent predetermined locations are separated by a distance of about 30 m.

The second portion of predetermined locations may then comprise at least location 130f, which is separated from location 130a by a distance of about 30 m, and location 130g which is separated from both locations 130f and 130b by about 30 m.

In the embodiment of FIG. 5, location 130f is within a threshold distance from location 130c, whereby these may be considered to form a mutual location. Location 130g is also in this exemplary wind turbine configuration within a threshold distance from location 130d, whereby these may be considered to form a mutual location.

In the example of FIG. 5, connectors may be provided at Z6.1 (location 130a), Z32 (location 130c/130f), Z62 (location 130g/130d), and Z91.9 (location 130b), while surge protection devices may be provided at Z6.1 (location 130a), Z32 (location 130c/130f), Z61 (location 130g/130d), Z92 (location 130b), and Z97 (location 130e).

In addition to the above disclosed locations, surge protection devices 128f, 128f′, and 128f″ may be provided at Z0.1 (before connection to the power supply 124) to couple the power cables 122a, 122b, and 122c to the lightning conductor 112, substantially corresponding to or being considered as a location of root end points of the power cables, to prevent excessive voltage from being able to reach the power supply.

In different embodiments where the conductive elements, e.g. spar caps or other structural support elements and heating mats and/or other electrical devices have differing geometries and mutual placements along the blade axis, the number and placement of the predetermined locations (of either of the first and second portions of them) may differ from that of FIG. 5.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. A wind turbine blade comprising a blade body, at least three electrically conductive elements comprising conductive material, said conductive elements optionally comprising at least one lightning conductor, at least one spar cap, and at least one heating arrangement, and a potential control arrangement, wherein the at least three conductive elements have longitudinal axes that are essentially nondirectional with a longitudinal axis of the blade body, and
said potential control arrangement comprises a plurality of coupling devices, each of which coupling at least two of said conductive elements, each coupling device being positioned at predetermined locations with respect to a blade axis being a longitudinal axis of the blade body, wherein
at least a first portion of said predetermined locations are terminal locations based at least on locations of structural discontinuation regarding at least two of the conductive elements, the first portion comprising at least one terminal location relating to a first conductive element and at least one terminal location relating to a second conductive element, and
at least a second portion of said predetermined locations are within a selected maximum distance from a terminal location or within a selected maximum distance from an adjacent predetermined location.

2. The wind turbine blade of claim 1, wherein the potential control arrangement is adapted to maintain the voltage difference between at least two coupled conductive elements below a threshold value, preferably below an estimated breakdown voltage.

3. The wind turbine blade of claim 1, wherein at least one of the predetermined locations or within a selected threshold distance from the at least one predetermined location, at least a first coupling device is arranged to couple a first conductive element to a second conductive element and a second coupling device is arranged to couple the first conductive element to a third conductive element.

4. The wind turbine blade of claim 3, wherein the selected threshold distance is 10 m or 5 m, optionally wherein the selected threshold distance is based at least on a distance between the first conductive element and the second conductive element at the considered predetermined location.

5. The wind turbine blade of claim 1, wherein the terminal locations are based on end points of the considered conductive elements and at least one second portion of predetermined locations are at predetermined intervals along the blade axis, adjacent predetermined locations being within the selected maximum distance from each other, said predetermined intervals preferably being essentially even intervals or said intervals differing from each other by under a selected threshold interval, such as under 15 m, preferably under 10 m, most preferably under 5 m.

6. The wind turbine blade of claim 1, wherein the selected maximum distance is under 50 m, preferably under 45 m, most preferably under 40 m, further wherein adjacent predetermined locations are separated by a distance of 10-50 m, preferably 15-40 m, most preferably 20-35 m, such as about 30 m.

7. The wind turbine blade of claim 1, wherein the conductive elements comprise at least one lightning conductor, said lightning conductor preferably being electrically connected to a ground potential.

8. The wind turbine blade of claim 7, wherein the plurality of coupling devices comprises at least one coupling device coupling the lightning conductor to a second conductive element and at least one coupling device connecting the lightning conductor to a third conductive element.

9. The wind turbine blade of claim 1, wherein the conductive elements comprise at least one electrically non-functional element, further wherein a coupling device coupling the electrically non-functional element to at least one other conductive element is a connector.

10. The wind turbine blade of claim 9, wherein the conductive elements comprise at least one structural support element, optionally a spar cap, further wherein the conductive elements additionally optionally comprise at least one further spar cap, wherein said spar caps preferably comprise carbon fiber.

11. The wind turbine blade of claim 1, wherein the conductive elements comprise at least one electrical device, further wherein a coupling device coupling the electrical device to at least one other conductive element is a surge protection device.

12. The wind turbine blade of claim 11, wherein the electrical device comprises at least one heating element, optionally at least one heating mat.

13. The wind turbine blade of claim 11, wherein the electrical device comprises at least one electrically powered device, optionally a heating mat, and at least one power cable for feeding electrical power to said electrically powered device, further wherein the coupling devices preferably couple each of the at least one electrically powered device and the at least one power cable to at least one other conductive element.

14. A method of manufacturing a wind turbine blade comprising:
providing a blade body,
providing at least three electrically conductive elements comprising conductive material, said conductive elements optionally comprising at least one lightning conductor, at least one spar cap, and at least one heating arrangement, wherein the at least three conductive elements have longitudinal axes that are essentially codirectional with a longitudinal axis of the blade body, and
providing a potential control arrangement by
providing a plurality of coupling devices, being configured to couple at least two of said conductive elements, and
positioning each of said coupling devices at predetermined locations with respect to a blade axis being a longitudinal axis of the blade body,
wherein at least a first portion of said predetermined locations are terminal locations based at least on locations of structural discontinuation regarding at least two of the conductive elements, the first portion comprising at least one terminal location relating to a first conductive element and at least one terminal location relating to a second conductive element, and
at least a second portion of said predetermined locations are within a selected maximum distance from a terminal location or within a selected maximum distance from an adjacent predetermined location.
